(19) United States
(12) Patent Application Publication
(10) Pub. No.: US 2017/0196173 A1
(43) Pub. Date: Jul. 13, 2017

(54) TREE TRIMMING CATCHER

(71) Applicant: Ricardo Tooru Naganuma, Long Beach, CA (US)

(72) Inventor: Ricardo Tooru Naganuma, Long Beach, CA (US)

(21) Appl. No.: 14/991,012

(22) Filed: Jan. 8, 2016

(51) Int. Cl. A01G 13/02; A01G 17/00; A01G 1/00

(52) U.S. Cl. CPC A01G 13/0268; A01G 1/001; A01G 13/0293; A01G 17/00

(57) ABSTRACT

A flexible panel configured with a central opening and slit from the opening to one edge and an operable closure device closing the slit.

The method includes deploying the panel about a tree and elevating the edges while trimming a tree.

### BACKGROUND

Field of the Invention

The present invention relates to tree and shrub trimming tasks and particularly to devices for catching tree or shrub trimmings for collection and disposal.

Description of the Related Art

The landscaping in many residential and commercial locations includes trees, shrubs, bushes and the like which must be trimmed from time to time.

The trimming task typically involves some type of manual or powered shearing or saw process which serves to remove branches, leaves, needles and limb sections that fall beneath the tree coming to rest in grass, flowers or other ground covering located under the tree. These trimmings must then be collected and removed without damage to the ground covering, flowers or the like. This is an extremely time consuming task, typically involving 50% or more of the total tree trimming project.

These challenges are exacerbated by the fact that landscaping layouts are of various different shapes and configurations of walls, decorative elements, flowers or the like beneath the tree thus making it impractical to lay down a canvas, tarpaulin or plastic cover in a manner which will conveniently collect the trimmings and which will not inflict injury or damage on the underlying flowers and ground covering. Thus, there exists a need for a device which might conveniently be deployed over the ground covering or plants or other decorative elements which may be positioned beneath the tree and which will collect trimmings dropping from the tree trimming process for convenient bagging and disposal.

There is also a need for such a device which can be reconfigured to fit into areas of different configurations and construction for catching the debris.

It is also important that such a device be constructed to be elevated above the underlying flowers and ground covering to avoid damage thereto and which will direct the debris to a central area for convenient collection and removal.

Landscaping tarps have been proposed in the past in the form of a large pouch and ring pulls for collecting large quantities of clippings. A device of this type is shown in U.S. Pat. No. 7,090,466 to Karkisek. A landscaping tarp formed with a flexible elastic sheath for tightly wrapping around a shrub has been proposed. Such a device is shown in U.S. Pat. No. 6,128,852 to Hansen with three pairs of Velcro loop connector hooks to pull the tarp closed for convenience in carrying.

It has also been proposed to construct a drop cloth incorporating a central opening and a slit to the edge to leave flaps on the opposite sides which separate to create space through which trimmings fall onto and through ground cover supporting the cloth thus still leaving clean up time for such trimmings. The central opening as well as the peripheral edges are lined by raised edges to purportedly block trimmings and debris from sliding off the cloth. A device of this type is shown in U.S. patent application Ser. No. 11/060,092 filed Feb. 17, 2005. Such devices have not gained popularity, to a great extent because they are expensive to manufacture with the raised barriers and are ineffective in collecting the falling trimmings and incorporate no means to prevent damage and injury to the underlying flowers and the like.

### SUMMARY OF THE INVENTION

The present invention includes a flexible panel formed with a central opening and a slit extending to one edge having a closure for closing the slit.

### BRIEF DESCRIPTION OF THE DRAWINGS

FIG. 1 is a perspective view of a tree and shrub trimming catch device incorporating the present invention;

FIG. 2 is a perspective view, in reduced scale, thereof as installed about a tree for trimming;

FIG. 3 is a vertical sectional view, in enlarged scale, taken along the line 3-3 of FIG. 1;

FIG. 4 is a view similar to FIG. 3 but of a second embodiment;

FIG. 5 is a similar view of a third embodiment;

FIG. 6 is a similar view of a fourth embodiment; and

FIG. 7 is a similar view of a fifth embodiment.

### DETAILED DESCRIPTION OF THE PREFERRED EMBODIMENTS

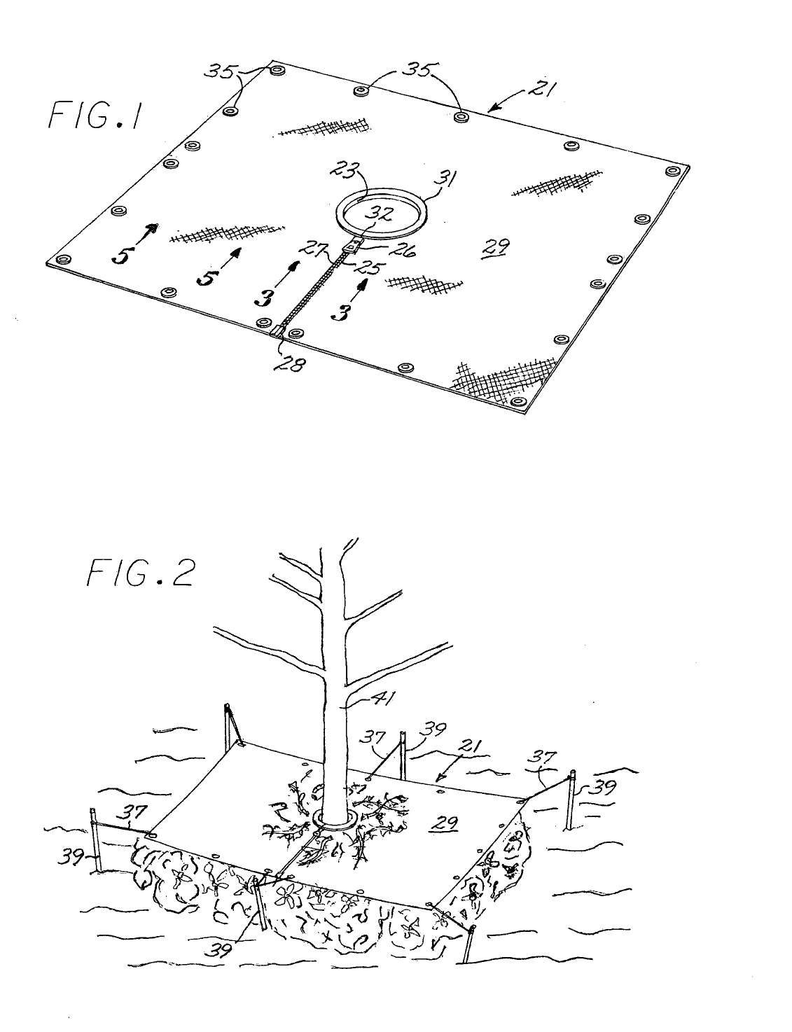

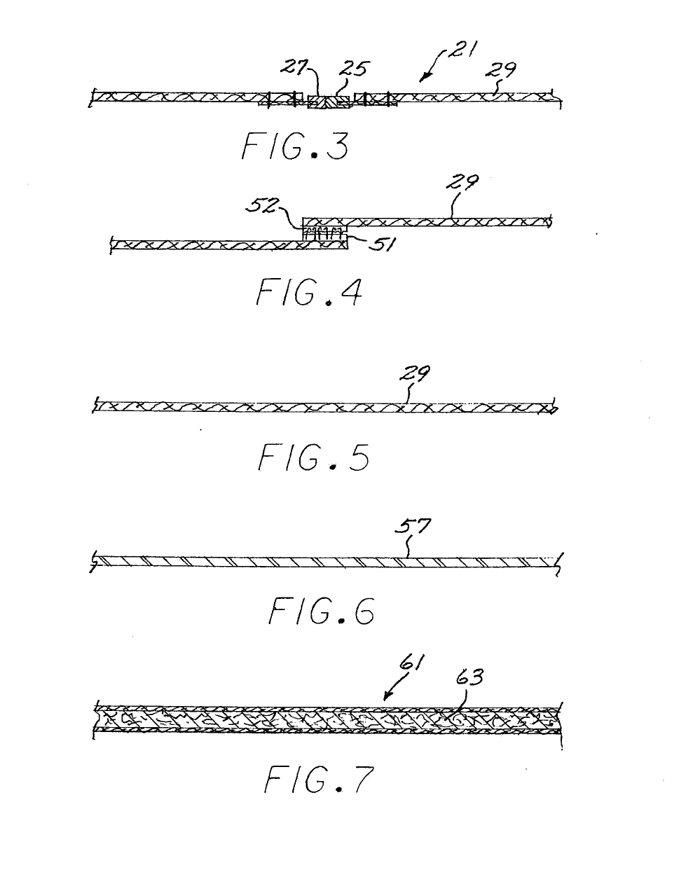

Referring to FIG. 1, the tree and shrub trim catcher device of the present invention includes, generally, a flexible panel device 21 formed centrally with an opening 23 and having a slit 25 extending to one edge thereof. The slit is closed and opened by means of a closure such as a robust zipper forming a closure 27.

Landscape personnel are faced with numerous different tasks for trimming trees and shrubs located in different locations, often with flowers or the like in the general vicinity and under the plumes of the trees and in many cases confined by walls and obstacles on one or more sides and sometimes complicated by flowers or other delicate vegetation or ground covering under the tree. Consequently, there is a need for a catch device which will accommodate these numerous different applications and which is convenient to use and effective to collect and retain the trimmings for disposal.

In that regard, my panel device 21 includes a flexible panel 29 which may be constructed of reinforced plastic, tarpaulin material or canvas. In one preferred embodiment, the opening 23 is lined with a neoprene collar 31 for reinforcement purposes and to add structure to maintain its structure during installation about a trunk of a tree.

Preferably, the panel 29 is not oversized and, for convenience of handling, I have found that a rectangular shape of four feet by eight feet or ten feet by twelve feet is convenient for many applications. In this preferred embodiment, the panel is constructed of opaque or near opaque material to block out sunlight and form a protective covering for any underlying vegetation or ground covering.

In this preferred embodiment, the panel device 21 incorporates a series of fasteners which may be in the form of grommets 35 spaced around the periphery thereof for receipt of ropes or tethers 37 to suspend the panel device from the tops of stakes 39 driven into the ground underneath the tree 41 to elevate the panel device over flowers 45 or other vegetation located underneath the tree.

The closure for the slot may take many forms but I have found that a robust zipper best serves the purpose for ease of operation and reliability, as will be apparent m the slit may extend from the central opening to any edge or even diagonally.

In various embodiments. different numbers of grommets 35 are included but, for the purpose of my exemplary embodiment, I incorporate six grommets spaced along each edge of the panel device.

In a second embodiment shown in FIG. 4, the device of the present invention includes strips hook and pile fasteners 51 to act as closures for closing overlapping marginal edges of the material on opposite sides of the slit 23. In practice , I have found that such strips should be about ½ to ⅝ths of an inch wide

The embodiment shown in FIG. 6 incorporates a panel 57 of transparent plastic configured to transmit sunlight so that the device can conveniently be utilized to, for instance, cover vegetation such as flowers 45 during, for instance, a cold spell and which will serve to transmit the sunrays to facilitate warming of the flowers as the sun rises in the morning.

The panel device 61 shown in FIG. 7 is similar to the panel device 21 shown in FIG. 1 except that it incorporates thermal insulating material 63 which will serve to, during cold weather, entrap heat beneath the panel at nighttime to guard against frost on the flowers 45 or the like.

In use, it will be appreciated that when the trimming task for the tree 41 is commenced, the zipper tabs 26 may be conveniently grasped and the zipper 27 opened by sliding the slider along the zipper to the edge to disengage the zipper clasp 28 to free the flaps formed on the opposite sides of the slit for folding back on themselves so the device might be fit around the trunk of the tree 41. In this regard, it will be appreciated that the collar 31 is formed with a slit at 32 for opening and access of the trunk. The zipper may then be closed to form a continuous panel about the trunk of the tree 41.

The panel device may then be conveniently rested momentarily on the tops of the flowers 45 deployed to the extended position shown in FIG. 2.

Tethers 37 might then be attached to the selected grommets 35 and stretched laterally and longitudinally to elevate the panel above the tops of the flowers 45 as by securing to the tops of stakes 39 or by attachment to nearby structures, such as other trees, fences or the like. In practice, the panel device is bagged somewhat in the center to form a slight hammock shape for directing the falling debris generally towards the center of the panel.

Then, as the trimming task is undertaken as by long reach tools or the like, the trimmings will fall downwardly on the panel device and tend to be drawn under the influence of gravity toward the center of the overall device to be collected centrally and away from the edges.

Experience has proven that this somewhat bagging configuration of the panel device elevated at the edges serves well for collecting the trimmings in a centralized area.

When the trimming process is completed, the panel device may then be conveniently manipulated to collect the trimmings for disposal. In that regard, the zipper may be again opened temporarily by grasping the tab 26 and drawing it laterally outwardly to open the slit 27 so that the flaps of the panel formed on the opposite sides of the slit might be raised and the edges of the panel folded slightly upwardly and inwardly as the panel device is relieved from the tethers 37 and drawn distally to the side of the tree opposite the zipper, all the time maintaining the peripheral edges somewhat elevated to control sliding of the debris toward the center and side opposite the zipper. As the panel device clears the tree trunk, the zipper may again be closed to prevent escape of trimmings through the slit.

As the panel device is translated away from the tree, the opposite end sections may be folded up thus trapping the debris centrally in the half of the panel opposite the zipper to then be rolled gently into a roll or pouch to be carried to the truck, bin or other disposal area where the trimmings may be discarded.

In particular applications, as when a tree or shrub is located adjacent wall or other barrier, the panel device of the present invention may be conveniently utilized by opening the zipper and laying the flaps on the opposite sides back over the distal half of the panel device so that the fold in the panel may be shifted up adjacent the wall or barrier and to protect against droppings of trimmings downwardly adjacent the wall.

Landscapers are often expected to take precautionary steps in the event of inclement weather and in instances when, as an example, frost is expected. The landscaper might cover the flowers or other groundcover with the device of the present invention utilizing the transparent panel material of FIG. 6 to thus capture some of the heat underneath the panel device at evening time and hold the warm air in during the nighttime and serve to allow sunlight to pass through the panel 57 as the sunrises in the morning to commence reheating the air captured under the panel to thus prevent or minimize any frost damage.

In an even more effective embodiment, the panel device 61 incorporates the thermal insulation 63 or, itself acts as a thermal insulator, to thus inhibit the escape of heat through the panel as night approaches and settles in thereby entrapping heat to prevent frost damage as the temperature drops late at night.

From the foregoing it will be apparent that the device of the present invention is an economical and convenient means for catching trimmings from a tree or shrub during the trimming procedure and for collection and disposal of such trimmings. The device in some embodiments provides for elevated deployment above the flowers or groundcover underneath a tree or the like to thereby avoid damage to the flowers during the trimming process.

Although the present invention has been described in detail with regard to the preferred embodiments and drawings thereof, it should be apparent to those of ordinary skill in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention.

I Claim:

1. A trimmings catcher for suspension around and embracing tree or shrub trunk to catch trimmings and comprising:
a flexible panel formed with a central opening for embracing the trunk and a slit extending from the opening to at least one edge of the panel;
a closure device for closing and opening the slit; and
fastener devices spaced about the edges of the panel for fastening to tethers to maintain the panel elevated under the tree or shrub while trimming thereof to catch tree debris.

2. The trimmings catcher device of claim 1 wherein:
the closure device includes a zipper.

3. The trimmings catcher device of claim 1 wherein:
the closure device includes hook and pile fasteners.

4. The trimmings catcher device of claim 1 wherein:
the panel is constructed of thermally insulated material.

5. The trimmings catcher device of claim 1 wherein:
the panel is constructed of transparent material.

6. The trimmings catcher device of claim 1 wherein:
the panel is substantially four feet by eight feet.

7. The trimmings catcher device of claim 1 wherein:
the panel device is substantially ten by twelve feet.

8. The trimmings catcher device of claim 1 that includes:
a pliable collar projecting at least part way around the opening.

9. A trimmings catcher device comprising:
a panel device for deployment about the trunk of a tree or shrub and including a central opening, the panel being formed with a slit projecting from the opening to one edge of the panel device; and
a closure for closing and opening the slit.

10. The trimmings catcher device of claim 9 wherein:
the closure device is in the form of a zipper.

11. A method of catching trimmings from a tree or shrub including:
a flexible panel device including a central opening and slit projecting from the opening to one side thereof and a closure device for the slit;
unzipping the zipper to open the slit to the opening;
deploying the panel device about a tree or shrub; and
trimming the shrub or tree with the closure device closed.

12. The method of claim 11 that includes:
during the trimming step, elevating the panel device above the ground and maintaining it elevated during the trimming process.

13. The method of claim 11 that includes:
selecting the panel device of a transparent material.
